(19) United States
(12) Patent Application Publication
(10) Pub. No.: US 2013/0110856 A1
(43) Pub. Date: May 2, 2013

(54) SEARCH SUPPORT APPARATUS, SEARCH SUPPORT METHOD, AND RECORDING MEDIUM OF SEARCH SUPPORT PROGRAM

(71) Applicant: FUJITSU LIMITED, Kawasaki-shi (JP)

(72) Inventor: Tomonori OTA, Kawasaki (JP)

(73) Assignee: FUJITSU LIMITED, Kawasaki-shi (JP)

(21) Appl. No.: 13/661,444

(22) Filed: Oct. 26, 2012

(30) Foreign Application Priority Data
Oct. 31, 2011 (JP) 2011-239783

(51) Int. Cl. G06F 17/30

(52) U.S. Cl. 707/758; 707/E17.014

(57) ABSTRACT

A support method of searching includes in a case that a plurality of display elements each of which is associated with attributes are specified, generating a search condition including attributes associated with the plurality of display elements, and a logical operator corresponding to a specifying method by which the plurality of display elements were specified, by a processor.

### CROSS-REFERENCE TO RELATED APPLICATION

This application is based upon and claims the benefit of priority of the prior Japanese Patent Application No. 2011-239783, filed on Oct. 31, 2011, the entire contents of which are incorporated herein by reference.

### FIELD

The embodiments discussed herein are related to searching for data.

### BACKGROUND

Heretofore, there has been technology for analyzing trends using various types of data. For example, there is a technique used in data analysis using data accumulated in a database, where data selected from a graph or table is refined, thereby narrowing down the object (also called “drill-down”).

As for related art, there is a system in which, for example, a report is created from a database and titled, natural language phrases are created from a menu and displayed, the database is queried, and the report is title such that a navigator itself is the title. Also, there is a system in which data is displayed as graphics, also enabling users to search data interactively. Also, there is an arrangement where functions of consolidating tuples with conditional judgment in a continuous region on conditional axes such as time and coordinates and so forth, and functions of managing the values in tables, are provided to an interactive server system.

However, with the related art, selecting multiple data from a graph or the like and performing data analysis such as drill-down is difficult. For example, it is difficult to determine what the intent of the user was in selecting the multiple data, and searching for data to use in the data analysis from the database is difficult.

### SUMMARY

According to an aspect of the invention, a support method of searching includes in a case that a plurality of display elements each of which is associated with attributes are specified, generating a search condition including attributes associated with the plurality of display elements, and a logical operator corresponding to a specifying method by which the plurality of display elements were specified, by a processor

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an embodiment of a support method of searching;

FIG. 2 is an explanatory diagram illustrating an embodiment of a support method of searching;

FIG. 3 illustrates a system configuration example of an information providing system;

FIG. 4 illustrates a hardware configuration example of a computer;

FIG. 5 illustrates an example of stored contents of a database;

FIG. 6 illustrates a functional configuration example of a client device;

FIG. 7 illustrates a functional configuration example of an information providing device;

FIG. 8 illustrates an example of drill-down;

FIG. 9 illustrates an example of drill-down;

FIG. 10 illustrates an example of drill-down;

FIG. 11 illustrates an example of drill-down;

FIG. 12 illustrates an example of chart display processing procedures of the client device;

FIG. 13 illustrates an example of information providing processing procedures by an information providing device;

FIG. 14 illustrates an example of specific processing procedures for first generating processing;

FIG. 15 illustrates an example of specific processing procedures for second generating processing;

FIG. 16 illustrates an example of specific processing procedures for second generating processing; and

FIG. 17A illustrates an example of specific processing procedures for data processing.

FIG. 17B illustrates an example of specific processing procedures for data processing.

### DESCRIPTION OF EMBODIMENTS

Hereinafter, an embodiment of a generating method, support method of searching, support program of searching and support apparatus of searching, according to the disclosure, will be described with reference to the attached drawings.

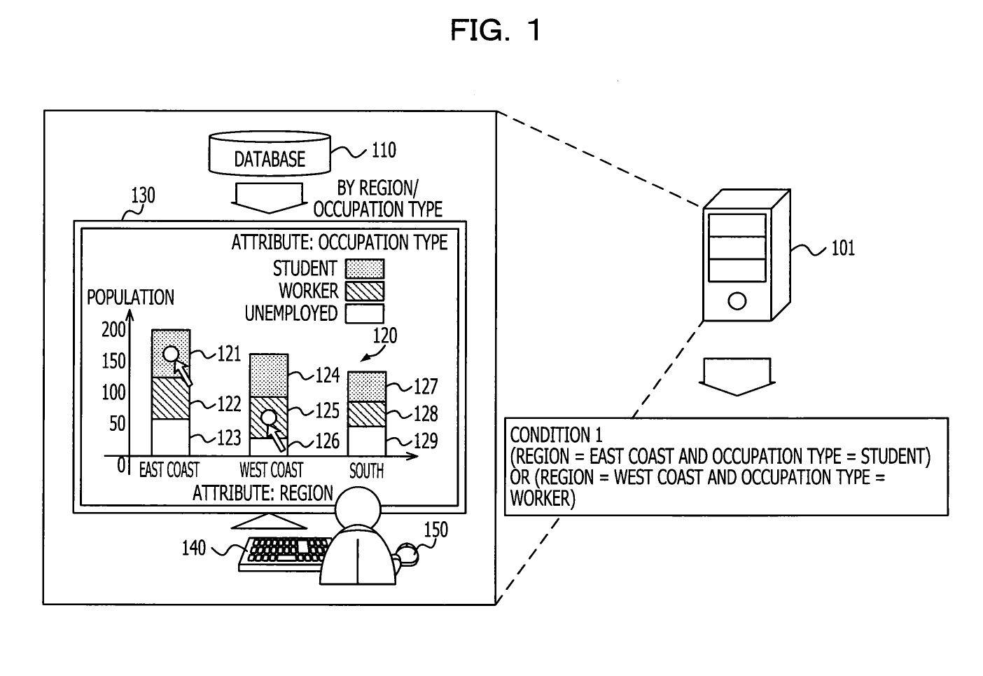

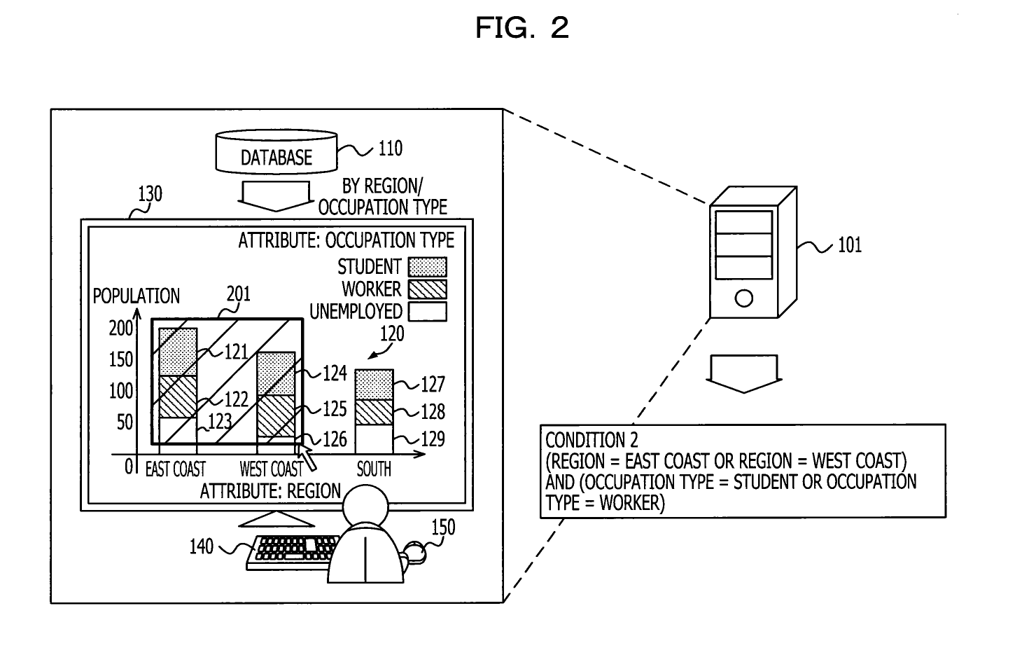

FIG. 1 is an explanatory diagram (part 1) illustrating an embodiment of a support system of searching. FIG. 2 is an explanatory diagram (part 2) illustrating the embodiment of a support system of searching. In FIGS. 1 and 2, a support apparatus 101 is a computer having functions for creating searching conditions to search data for analysis from a database 110.

Here, the database 110 stores a data group having multiple attributes. The database 110 stores data corresponding to combinations of attribute values of the attributes, included in the multiple attributes. The database 110 is a multidimensional database capable of searching for and tabulating data, while switching the object attributes one after another.

Examples of data include corporate sales, number of products sold, production of a product, population, and like numerical value information. Data is periodically or irregularly collected, and accumulated in the database 110. Also, the data to be analyzed is data used for data analysis, such as drill-down or drill-up.

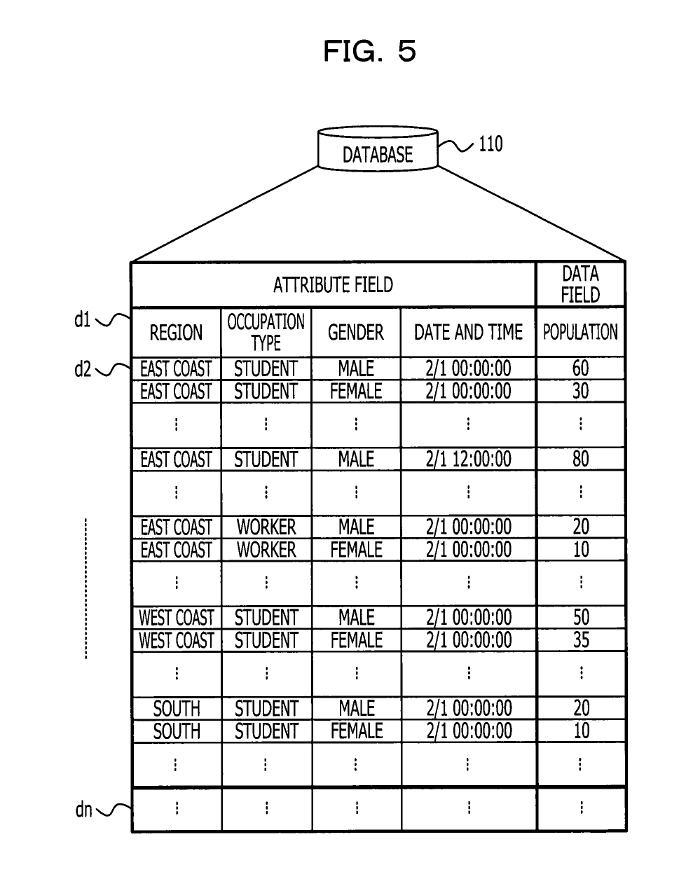

Hereinafter, a data group having multiple attributes stored in the database 110 will be written as “data group d1 through dn” (where n is a positive integer of 2 or greater). Also, in FIGS. 1 and 2, data d1 through dn is data representing population. An example of having attributes of “region”, “occupation type”, and “gender” will be described. The stored contents of the database 110 will be described later with reference to FIG. 5.

In FIG. 1, a graph 120 is a bar graph representing population for each region by occupation type. Specifically, the graph 120 is a chart representing consolidated data 121 through 129 where data in which the combination of attribute values of attributes “region” and “occupation type” in the data group d1 through dn are the same has been consolidated, in correlation with the combination of attribute values of attributes “region” and “occupation type”.

Here, the consolidated data 121 represents the population “100” of occupation type “student” in the region “East coast”. The consolidated data 122 represents the population “70” of occupation type “worker” in the region “East coast”. The consolidated data 123 represents the population “60” of occupation type “unemployed” in the region “East coast”.

Also, the consolidated data 124 represents the population “100” of occupation type “student” in the region “West coast”. The consolidated data 125 represents the population “90” of occupation type “worker” in the region “West coast”. The consolidated data 126 represents the population “30” of occupation type “unemployed” in the region “West coast”.

Also, the consolidated data 127 represents the population “500” of occupation type “student” in the region “South”. The consolidated data 128 represents the population “40” of occupation type “worker” in the region “South”. The consolidated data 129 represents the population “60” of occupation type “unemployed” in the region “South”.

The user views the graph 120 displayed on a display 130, and selects consolidated data from the consolidated data 121 through 129 to drill down. In the example in FIG. 1, the consolidated data 121 and consolidated data 125 have been directly instructed by operation input by the user by way of a left-click on a mouse 150 and pressing a control key on a keyboard 140. For example, the graph may be displayed on a touch screen instead of the display 130, and the consolidated data 121 through 129 displayed on the touch screen may be selected by operation input by the user by way of touching on corresponding area of the touch screen.

Operation input for directly instructing the consolidated data 121 and consolidated data 125 displayed on the display 130 is often performed in cases of the user wanting to perform pinpoint refinement and analysis of the consolidated data 121 and consolidated data 125.

Accordingly, the support apparatus 101 creates search conditions to search for data used in to performing refinement and analysis of the consolidated data 121 and 125, from the database 110. Specifically, the support apparatus 101 generates search conditions to search for data where a combination of attribute values for attributes “region” and “occupation type” are the same as the consolidated data in one of the consolidated data 121 and 125.

More specifically, the combination of attribute values for attributes “region” and “occupation type” corresponding to the consolidated data 121 are “region: East coast, Occupation: student”. Also, the combination of attribute values for attributes “region” and “occupation type” corresponding to the consolidated data 125 are “region: West coast, Occupation: worker”. Accordingly, the following conditional expression 1, for example, is generated as search conditions.

(“region=East coast” AND “occupation=student”) OR (“region=West coast” AND “occupation type=worker”) Conditional Expression 1

That is to say, data satisfying the above conditional expression 1 is data where the attribute value for “region” is “East coast” and the attribute value for “occupation type” is “student”, or data where the attribute value for “region” is “West coast” and the attribute value for “occupation type” is “worker”. By searching for data satisfying the above conditional expression 1 from the database 110, the data for performing refinement and analysis of the consolidated data 121 and 125 can be obtained.

On the other hand, with the example in FIG. 2, a range 201 including the consolidated data 121, 122, 124, and 125 displayed on the display 1301 has been instructed by operation input by the user using a drag & drop operation by the mouse 150.

Operation input for instructing the range 201 including the consolidated data 121, 122, 124, and 125 displayed on the display 130 is often performed in cases of the user wanting to perform an inclusive analysis of the consolidated data 121, 122, 124, and 125.

Accordingly, the support apparatus 101 creates search conditions to perform a blanket search for data corresponding to the attribute values of attribute “region” or “occupation type” of the consolidated data 121, 122, 124, and 125, from the database 110. Specifically, the support apparatus 101 generates search conditions to search for data where the attribute values of each of the attributes “region” and “occupation type” are the same as attribute values corresponding to consolidated data in one of the consolidated data 121, 122, 124, and 125.

More specifically, attribute values of attribute “region” corresponding to one of the consolidated data 121, 122, 124, and 125 is “East coast” or “West coast”. Also, attribute values of attribute “occupation type” corresponding to one of the consolidated data 121, 122, 124, and 125 is “student” or “worker”. Accordingly, the following conditional expression 2, for example, is generated as search conditions.

(“region=East coast” OR “region=West coast”) AND (“occupation type=student” OR “occupation type=worker”) Conditional Expression 2

That is to say, data satisfying the above conditional expression 2 is data where the attribute value of attribute “region” is “East coast” or “West coast”, and the attribute value of attribute “occupation type” is “student” or worker”. By searching data satisfying the above conditional expression 2 from the database 110, data to be used in performing an inclusive analysis of the consolidated data 121, 122, 124, and 125 can be obtained.

According to the present support method of searching described above, search conditions for searching for data to be used for data analysis can be generated in accordance with user operation input of selecting multiple consolidated data displayed on a chart on the display 130, in order to perform data analysis such as drill-down.

Specifically, in the event that operation input is performed directly instructing individual consolidated data displayed on the display 130, searching conditions for searching for data to be used in performing pinpoint refinement and analysis of individual consolidated data can be generated. On the other hand in the event that operation input instructing a range including multiple consolidated data displayed on the display 130 is performed, searching conditions for searching for data to be used in performing inclusive analysis of multiple consolidated data can be generated.

Thus, according to the present support system of searching, the intent of user selections can be determined depending on whether the operations of selecting multiple consolidated data from a chart displayed on the display 130 to be drilled down are direction instructions or range instructions. A conditional expression for searching for data which can create a chart which the user expects can then be generated.

Next, an information providing system 300 according to the embodiment will be described. The following is a description of the case of applying the support apparatus 101 illustrated in FIGS. 1 and 2 to an information providing apparatus 301 of the information providing system 300.

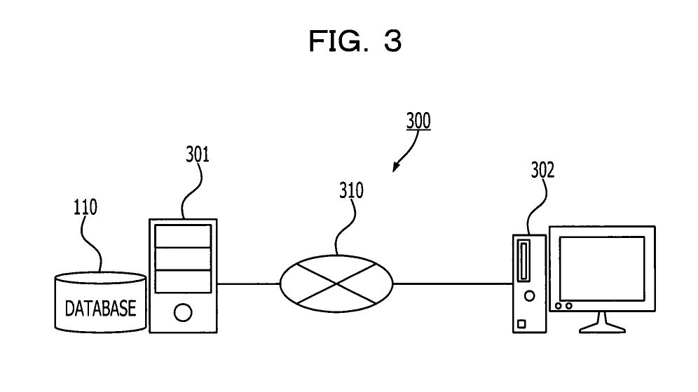

FIG. 3 is an explanatory diagram illustrating a system configuration example of the information providing system 300 according to the embodiment. In FIG. 3, the information providing system 300 includes the information providing apparatus 301 and a client apparatus 302. With the information providing system 300, the information providing apparatus 301 and client apparatus 302 are connected via a cable or wireless network 310. The network 310 is, for example, a LAN (Local Area Network), WAN (Wide Area Network), the Internet, or the like.

Now, the information providing apparatus 301 is a computer which has a database 110 and provides chart information representing charts, to the client apparatus 302. Examples of charts include bar graphs, line graphs, pie charts, tables, and so forth. Specifically, a chart represents consolidated data in which, of data groups dl through do having multiple attributes, data having the same combination of attribute values of two or more attributes selected from multiple attributes, is correlated with the combination of attribute values of the two or more attributes. A more specific example of a chart is the graph 120 illustrated in FIGS. 1 and 2.

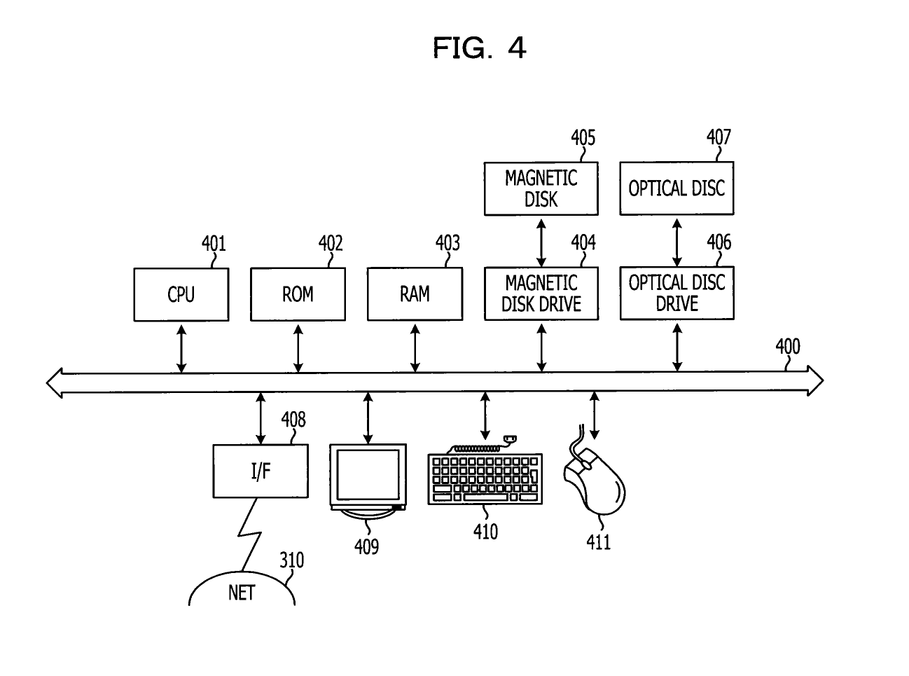

The client apparatus 302 is a computer which a user of the information providing system 300 uses. The client apparatus 302 has a function to display chart information provided by the information providing apparatus 301 on a display 409 illustrated in FIG. 4 which will be described later.

Specifically, for example, the client apparatus 302 transmits a chart display request to the information providing apparatus 301. Now a chart display request is a request for chart information, representing a chart to be displayed. The chart to be displayed may be set beforehand, or may be selected by the user from multiple charts.

Upon receiving the chart display request from the client apparatus 302, the information providing apparatus 301 creates chart information representing the chart to be displayed. The information providing apparatus 301 transmits the created chart information to the client apparatus 302. The client apparatus 302 receives the chart information from the information providing apparatus 301 and displays this on the display 409.

The user can determine some sort of trend while watching the chart displayed on the display 409 of the client apparatus 302, or perform data analysis such as drill-up or drill-down to find the cause of a certain phenomenon, for example.

Next, the hardware configuration of the computers (information providing apparatus 301 and client apparatus 302) illustrated in FIG. 3 will be described.

FIG. 4 is a block diagram illustrating a hardware configuration example of a computer according to the embodiment. In FIG. 4, the computer has a CPU (Central Processing Unit) 401, ROM (Read-Only Memory) 402, RAM (Random Access Memory) 403, a magnetic disk drive 404, a magnetic disk 405, an optical disc drive 406, an optical disc 407, an interface 408, a display 409, a keyboard 410, and a mouse 411. The components are connected to each other by a bus 400. For example, the computer may further include a touch screen as described above.

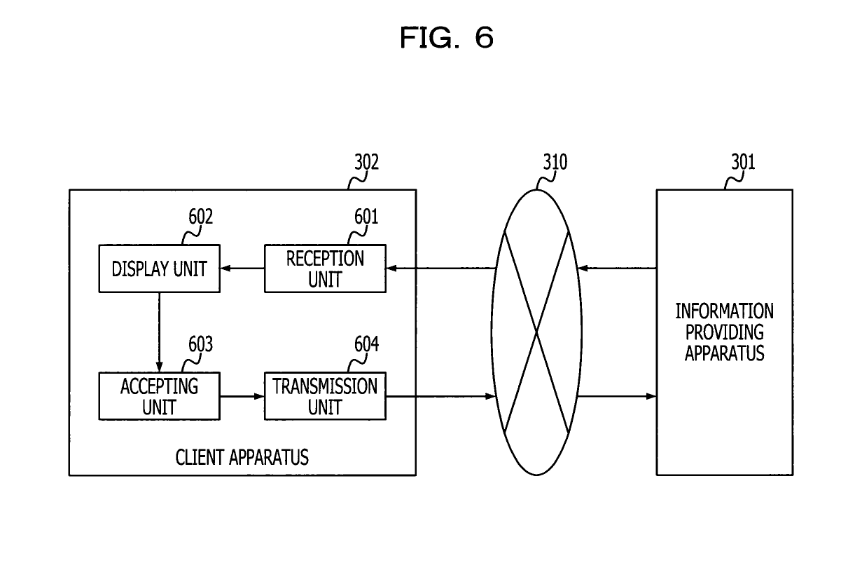

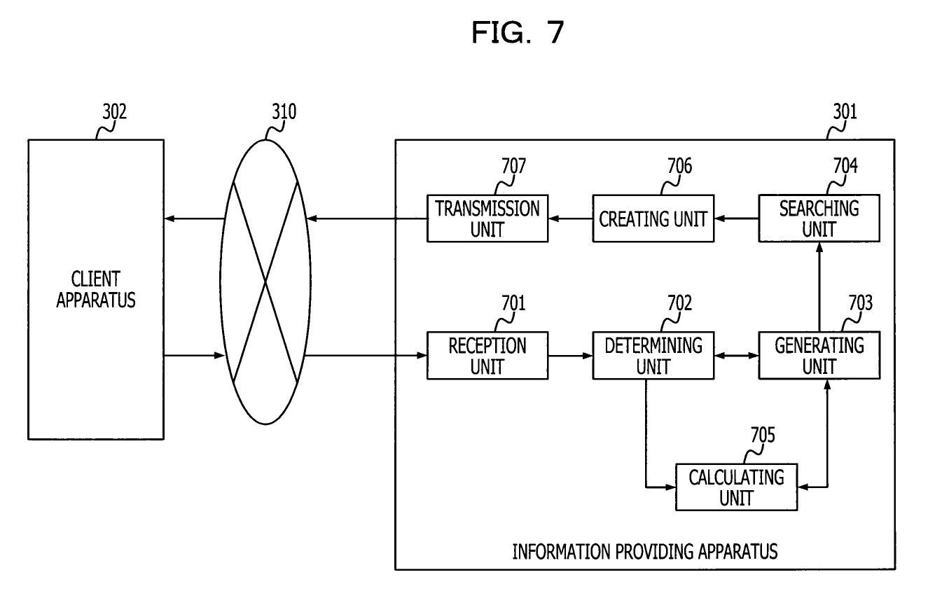

Here, the CPU 401 controls the entire computer. The CPU 401 is an example of a processor which reads out and executes the support program of searching stored in the ROM 402 or the magnetic disk 405, so as to implement respective functions by means of units illustrated in FIGS. 6 and 7 (as will hereinafter be described in detail). The processor is a hardware to carry out operations based on at least one program (such as the support program of searching) and control other hardware, such as the CPU 401, a GPU (Graphics Processing Unit), FPU (Floating point number Processing Unit) and DSP (Digital signal Processor). The RAM 402 stores programs such as a boot program. The RAM 403 is used as a work area of the CPU 401. The magnetic disk drive 404 controls read/write of data as to the magnetic disk 405 under control of the CPU 401. The magnetic disk 405 stores data written under control of the magnetic disk drive 404.

The optical disc drive 406 controls read/write of data as to and from the optical disc 407 under control of the CPU 401. The optical disc 407 stores data written under control of the optical disc drive 406, and allows the computer to read data stored therein.

The interface 408 is connected to the network 310 via a communication line, and is connected to other apparatuses via the network 310. The interface 408 governs the network 310 and an internal interface, so as to control input/output from and to external apparatuses. Examples of the interface 408 include a modem, LAN adaptor, and so forth.

The display 409 displays cursors, icons, took boxes, as well as documents, images, functional information, and other like data. Examples of the display 409 include Cathode Ray Tube (also called “CRT”) displays, Thin-Film Transistor (also called “TFT”) liquid crystal displays, plasma displays, and so forth. The display 130 illustrated in FIG. 1 corresponds to this display 409, for example.

The keyboard 410 has keys for input of characters, numerals, and various types of instructions and so forth, and is for data input. The keyboard 410 may be a touch panel type input pad, a numeric keypad, or the like. The mouse 411 performs moving of a cursor, selecting ranges, moving windows and changing the size thereof, and so forth. Other devices, such as trackballs, joysticks, or the like, may be used instead, as long has they have similar functions as a pointing device. The keyboard 140 and mouse 150 illustrated in FIG. 1 correspond to the keyboard 410 and mouse 411, for example.

Note that of the above-described configurations, the information providing apparatus 301 does not have to have the optical disc drive 406, optical disc 407, display 409, and keyboard 410 and mouse 411, for example. Also, the client apparatus 302 may have a scanner, printer, or the like, for example.

Now, description will be made regarding the stored contents of the database 110 which the information providing apparatus 301 has. The database 110 is realized by storage devices such as the RAM 403, magnetic disk 405, optical disc 407, and so forth, of the information providing apparatus 301, illustrated in FIG. 4 for example.

FIG. 5 is an explanatory diagram illustrating an example of the stored contents of the database 110. In FIG. 5, the database 110 has attribute fields and data fields, and by setting information for each field, stores as records the data d1 through do for each combination of the attribute values of the attributes set in the attribute fields.

Now, an attribute field is a field for setting an attribute characterizing data. Here, illustrated as attributes are region, occupation type, gender, and date-and-time. Attribute values of “region” are, for example, “East coast”, “West coast”, and “South”. Attribute values of “occupation type” are, for example, “student”, “worker”, and “unemployed”. Attribute values of “gender” are, for example, “male” and “female”. Attribute values of “date-and-time” are, for example, “2/1 00:00:00” (meaning 00 minutes and 00 seconds past midnight, February 1), “2/1 12:00:00”, and so forth.

Also, types are set to the attributes, representing the types of the attributes. Attribute types include consecutive value types where the attribute values of the attributes are consecutive, and discrete value types where the attribute values of the attributes are not consecutive. For example, the type of the attribute “region” is a discrete value type, since the attribute values of the attribute “region” are not consecutive. The type of the attribute “occupation type” is a discrete value type, since the attribute values of the attribute “occupation type” are not consecutive.

The type of the attribute “gender” is a discrete value type, since the attribute values of the attribute “gender” are not consecutive. The type of the attribute “date-and-time” is a consecutive value type, since the attribute values of the attribute “date-and-time” are consecutive. The type information identifying the types of the attributes is stored in a storage device such as the RAM 403, magnetic disk 405, optical disc 407, or the like of the information providing apparatus 301, in a manner correlated with the attributes set in the attribute fields of the database 110.

Data fields are fields where information serving as the data proper is set. The information serving as the data proper is numerical information representing, for example, statistical values, tabular values, measurement values, and so forth. Here, population is illustrated as information serving as the data proper.

For example, data d1 indicates that the population of region “East coast” that is of occupation “student”, gender of “male”, at date-and-time “2/1 00:00:00” is “60”. Also, data d2 indicates that the population of region “East coast” that is of occupation “student”, gender of “female”, at date-and-time “2/1 00:00:00” is “30”.

Next, a functional configuration example of the client apparatus 302 will be described. FIG. 6 is a block diagram illustrating a functional configuration example of the client apparatus 302 according to the embodiment. In FIG. 6, the client apparatus 302 is of a configuration including a reception unit 601, a display unit 602, an accepting unit 603, and a transmission unit 604. These functions serving as a control unit (reception unit 601 through transmission unit 604) specifically realize the functions thereof by a program stored in the storage devices such as the ROM 402, RAM 403, magnetic disk 405, optical disc 407, and so forth, of the client apparatus 302 illustrated in FIG. 4, being executed by the CPU 401, and by the interface 408 of the client apparatus 302. Also, the processing results of the functional units are stored in the storage devices such as the RAM 403, magnetic disk 405, optical disc 407, and so forth, of the client apparatus 302.

The reception unit 601 has a function of receiving chart information representing charts from the information providing apparatus 301. As described above, a chart represents consolidated data in which, of data groups dl through dn having multiple attributes, data having the same combination of attribute values of two or more attributes selected from multiple attributes, is correlated with the combination of attribute values of the two or more attributes. A chart includes part or all of consolidated data for each combination of attribute data of two or more attributes selected from multiple attributes.

Now, a specific example of consolidated data will be described by way of the example of stored contents of the database 110 illustrated in FIG. 5. Here, we will say that the two or more attributes selected from the multiple attributes “region”, “occupation type”, “gender”, and “date-and-time”, are “region”, “occupation type”, and “date-and-time”. In this case, of the data groups dl through dn, the data where the combination of attribute values of the attributes “region”, “occupation type”, and “date-and-time”, are the same, are data d1 and d2, for example.

Accordingly, the consolidated data consolidating the data d1 and d2 is data representing population of region “East coast” that is of occupation “student”, at date-and-time “2/1 00:00:00” is “90”. This population of “90” is the population “60” represented by data d1 and the population “30” represented by data d2 that has been tabulated.

The display unit 602 has a function of displaying a chart representing the received chart information on the display 409 illustrated in FIG. 4. Specifically, the display unit 602 displays bar graphs, line graphs, pie charts, tables, and so forth, which the chart information represents, on the display 409.

The accepting unit 603 has a function of accepting operation input from the user, selecting consolidated data from the chart displayed on the display 409. Operation input by the user includes operation input for directly instructing consolidated data from the chart to select consolidated data from the chart (hereinafter referred to as “first operation input”). Also, operation input by the user includes operation input for instructing a range on a display region including the chart on the display 409 to select consolidated data from the chart (hereinafter referred to as “second operation input”).

Specifically, for example, the accepting unit 603 accepts the first operation input for selecting multiple consolidated data from the chart by a left-click on the mouse 411 and pressing the control key on the keyboard 410 (e.g., see FIG. 1). Also, for example, the accepting unit 603 accepts the second operation input selecting multiple consolidated data from the chart by performing a drag & drop operation with the mouse 411 to specify a range on a display region including the chart (e.g., see FIG. 2).

The transmission unit 604 has a function of transmitting the accepted accepting results to the information providing apparatus 301. Note that the accepting results include the identification information of the chart displayed on the display 409, and the identification information of the consolidated data selected from the chart. Also, the accepting results include operation information for identifying whether the user operation input whereby consolidated data was selected from the chart was a first operation input or second operation input.

Next, a functional configuration example of the information providing apparatus 301 will be described. FIG. 7 is a block diagram illustrating a functional configuration example of the information providing apparatus 301 according to the embodiment. In FIG. 7, the information providing apparatus 301 includes a reception unit 701, a determining unit 702, a generating unit 703, a searching unit 704, a calculating unit 705, a creating unit 706, and a transmission unit 707. These functions serving as a control unit (reception unit 701 through transmission unit 707) specifically realize the functions thereof by a program stored in the storage devices such as the ROM 402, RAM 403, magnetic disk 405, optical disc 407, and so forth, of the information providing apparatus 301 illustrated in FIG. 4, being executed by the CPU 401, and by the interface 408 of the information providing apparatus 301. Also, the processing results of the functional units are stored in the storage devices such as the RAM 403, magnetic disk 405, optical disc 407, and so forth, of the information providing apparatus 301.

The reception unit 701 has a function of receiving accepting results from the client apparatus 302. As described above, the accepting results include identification information of the chart and identification information of the consolidated data selected from the chart. Also, the accepting results include operation information for identifying whether the user operation input whereby consolidated data was selected from the chart was a first operation input or second operation input.

In the following description, the consolidated data selected from a chart identified from the accepting results will be written as “consolidated data D1 through Dm” (where m is a positive integer of 1 or greater). Also, arbitrary consolidated data of the consolidated data D1 through Dm will be written as “consolidated data Dj” (where m=1, 2, . . . , m). Further, two or more attributes selected from the multiple attributes which the data group d1 through do has will be written as “attributes A1 through AK” (where K is a positive integer of 2 or greater). Moreover, arbitrary attributes of attributes A1 through AK will be written as “attribute Ak” (where k=1, 2, . . . , K). Further, an attribute value of attribute Ak as to consolidated data Dj will be written as “attribute value Vⱼk”.

The determining unit 702 has a function of determining whether operation input for selecting consolidated data D1 through Dm is first operation input or second operation input, based on the received accepting results. Specifically, for example, the determining unit 702 determines whether first operation input or second operation input, based on operation information included in the accepting results.

Also, the determining unit 702 has a function of determining whether the type of the attribute Ak is a discrete value type or consecutive value type. Specifically, for example, the determining unit 702 references the type information of the attribute Ak and determines whether the type of the attribute Ak is a discrete value type or consecutive value type.

The generating unit 703 has a function of generating search conditions for searching for data to be analyzed from the data group d1 through dn, based on the determined determination results and the combination of attribute values of attributes A1 through AK corresponding to each consolidated data Dj.

Now, description will be made regarding an example of specific processing performed by the generating unit 703, according to whether the operating input for selecting the consolidated data D1 through Dm is a case of first operating input and a case of second operating input.

First, description will be made regarding a case where the operating input for selecting consolidated data D1 through Dm is the first operating input. In this case, the generating unit 703 generates searching conditions for searching data from the data group d1 through dn where the combination of attribute values of attributes A1 through AK is the same as one of the consolidated data Dj of consolidated data D1 through Dm.

Specifically, for example, as illustrated in the following Expression (1), the generating unit 703 generates a conditional expression Ej for each consolidated data Dj from the AND of conditional expressions where the attribute values for each attribute Ak is the attribute value Vⱼk of the attribute Ak corresponding to the consolidated data Dj. Also, “AND” in the following Expression is a logical AND operator.

Ej=“A1=Vⱼ1” AND “A2=Vⱼ2” AND . . . AND “AK=VⱼK” (1)

Then, as illustrated in the following Expression (2), the generating unit 703 generates a conditional expression E from the OR of the conditional expression Ej for each consolidated data Dj, so as to have search conditions searching for the data to be analyzed from the data group d1 through dn. Also, “OR” in the following Expression is a logical OR operator.

E=“E1” OR “E2” OR . . . OR “Em” (2)

Next, description will be made regarding a case where the operating input for selecting consolidated data D1 through Dm is the second operating input. In this case, the generating unit 703 generates a conditional expression Ek for each attribute Ak, based on the determination results of whether the type of the attribute Ak is a discrete value type or consecutive value type. As illustrated in the following Expression (3), the generating unit 703 generates a conditional expression E serving as searching conditions for searching data to be analyzed from the data group d1 through dn, from the AND of conditional expressions Ek for each attribute Ak.

E=“E1” AND “E2” AND . . . AND “EK” (3)

Now, description will be made regarding specific processing contents for generating a conditional expression Ek for each attribute Ak. First, description will be made regarding a case where the type of the attribute Ak is a discrete value type. In this case, the generating unit 703 generates a condition expression Ek for searching data from the data group d1 through dn where the attribute value of attributes Ak is the same attribute value as the attribute Ak corresponding to one of the consolidated data Dj of consolidated data D1 through Dm.

More specifically, for example, as with the following expression (4), the generating unit 703 generates a conditional expression Ek of the attribute Ak from the AND of conditional expressions where the attribute value of the attribute Ak is the same as the attribute value of the attribute Ak corresponding to one of the consolidated data Dj of consolidated data D1 through Dm.

Ek=“Ak=Vⱼk” OR “Ak=V₂k” OR . . . OR “Ak=Vₘk” (4)

Next, description will be made regarding a case where the type of attribute Ak is a consecutive value type. In this case, The generating unit 703 generates a searching expression Ek, for searching for data included in a range where the attribute value of attribute Ak is included in a range of minimum value Vkₘᵢₙ through maximum value Vkₘₐₓ out of attribute values V₁k through Vₘk corresponding to consolidated data Di through Dm, out of the data group d1 through dn.

For example, in the event that the attribute Ak represents time such as date-and-time, the minimum value Vkₘᵢₙ represents the oldest attribute value of attribute values V₁k through Vₘk, and the maximum value Vkₘₐₓ represents the newest attribute value of attribute values V₁k through Vₘk. Specifically, for example, as in the following Expression (5), the generating unit 703 generates a conditional expression Ek for attribute Ak from the AND of a conditional expression where the attribute value of the attribute Ak is the minimum value Vkₘᵢₙ or greater and a conditional expression where the attribute value of the attribute Ak is the maximum value Vkₘₐₓ or smaller.

Ek=“Vkₘᵢₙ≦Ak” AND “Ak≦Vkₘₐₓ” (5)

The searching unit 704 has a function to search for data to be analyzed from the data group d1 through dn, based on the generated searching conditions. Specifically, the searching unit 704 searches for data satisfying the generated conditional expression E, from the data group d1 through dn stored in the database 110.

The calculating unit 705 has a function to calculate the increment intervals of attribute values of consecutive value type attribute Ak out of the attributes A1 through AK. The increment intervals of attribute values of consecutive value type attribute Ak are the increment intervals of attribute values of consecutive value type attribute Ak of data to be analyzed. Hereinafter, the increment intervals of attribute values of consecutive value type attribute Ak will be referred to as “granularity of attribute Ak”.

Now, let us consider what sort of details the user details to see from the chart displayed on the display 409. To this end, in the case of attribute Ak of a consecutive value type, what details the user anticipates can be determined by using the data intervals displayed on the display 409 as a reference. Accordingly, the granularity of the attribute Ak is obtained, so as to determine how the user wants to drill down.

First, a case where the operation input is the first operation input where the user selects consolidated data D1 through Dm will be described. In this case, for example, the calculating unit 705 calculates the granularity of the attribute Ak of a consecutive value type, out of the attribute values of the consecutive value type attribute Ak of each consolidated data included in the chart, based on intervals between consecutive different attribute values.

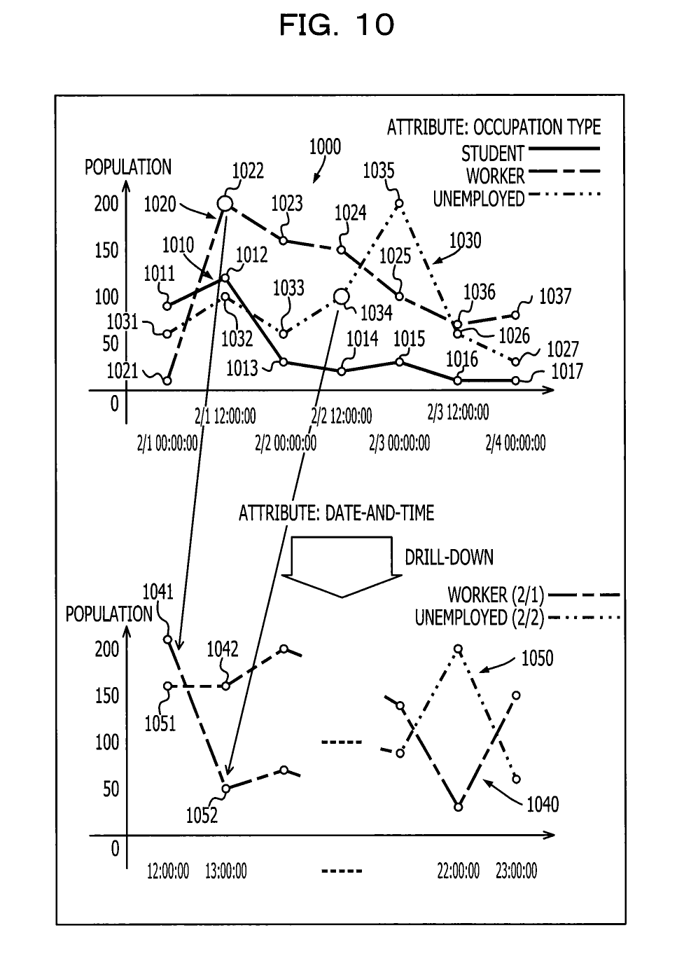

For example, let us say that the consecutive value type attribute Ak is attribute “date-and-time” and the time interval between consecutive difference attribute values is 12 hours (e.g., see FIG. 10 to be described later). In this case, the calculating unit 705 can calculate the granularity of the consecutive value type attribute Ak as being a smaller time increment (e.g., one hour, one minute, one second, etc.) than the average value h1 of time intervals of the consecutive different attribute values (12 hours here).

At this time, the calculating unit 705 may calculate a time increment which is smaller than the above average value h1, and also close to the average value h2 of time intervals of the consecutive different attribute values out of the attribute values V₁k through Vₘk of the consecutive value type attributes Ak of the consolidated data D1 through Dm, as the granularity of the attribute Ak. For example, with the above average value h1 as 12 hours, and the above average value h2 as one day, the calculating unit 705 calculates one hour, which is a time increment smaller than the average value h1 and is close to the average value h2, as the granularity of the attribute Ak.

Next, a case of the second operation input where the user selects consolidated data D1 through Dm will be described. In this case, for example, the calculating unit 705 calculates the granularity of the attribute Ak of a consecutive value type, based on a first interval and a second interval. Here, the first interval is the interval between the smallest value and greatest value of the attribute values of the consecutive value type attribute Ak corresponding to each consolidated data included in the chart. The second interval is the interval between the minimum value Vkₘᵢₙ through maximum value Vkₘₐₓ out of attribute values of the consecutive value type attribute Ak corresponding to consolidated data D1 through Dm.

More specifically, in the event that the second interval is half of the first interval or smaller, the calculating unit 705 may calculate any interval increment smaller than the second interval as the granularity of the consecutive value type attribute Ak. Also, in the event that the second interval is greater than half of the first interval, the calculating unit 705 may calculate any interval increment the same as or greater than the second interval as the granularity of the consecutive value type attribute Ak.

For example, let us say that the first interval is three days, and the second interval is one day. In this case, the second interval is half of the first interval or smaller, so the calculating unit 705 calculates the time increment “one hour” which is the greatest time increment smaller than “one day” which is the second interval, as being the granularity of the consecutive value type attribute Ak. Also, let us say that the first interval is three days, and the second interval is two days. In this case, the second interval is greater than half of the first interval, so the calculating unit 705 calculates the time increment “one month” which is the smallest time increment greater than “two days” which is the second interval, as being the granularity of the consecutive value type attribute Ak.

Also, the searching unit 704 may search the data to be analyzed from the data group d1 through dn, based on the generated searching conditions and the calculated granularity of the consecutive value type attribute Ak. More specifically, for example, the generating unit 703 changes the attribute values for the consecutive value type attribute Ak included in the conditional expression E in accordance with the calculated granularity of the consecutive value type attribute Ak.

For example, let us say that the consecutive value type attribute Ak is attribute “date-and-time”, and the granularity of the attribute “date-and-time” is “one hour”. Also, let us say that the attribute value of the attribute “date-and-time” of the consolidated data Dj is “2/1 12:00:00”. In this case, the generating unit 703 truncates the portion of the attribute value “2/1 12:00:00” of the attribute “date-and-time” of the consolidated data Dj which is smaller than the granularity “one hour”, so as to change the attribute values of the attribute “date-and-time” to “2/1 12 o'clock”.

That is to say, the generating unit 703 processes the consolidated data Dj in accordance with the granularity of the attribute Ak. As a result, a conditional expression E based on the post-processing consolidated data Dj where the attribute value of the attribute Ak has been changed in accordance with the granularity of the attribute Ak is generated. The searching unit 704 then searches the data group d1 through dn stored in the database 110 for data satisfying the conditional expression E based on the post-processing consolidated data Dj. As a result, data of the granularity of the attribute Ak is searched regarding the consecutive value type attribute Ak.

The creating unit 706 has a function to create a chart where, of the data to be analyzed that is searched, consolidated data of which the combination of attributes A1 through AK and attribute values of attribute AL is the same, is represented in a manner correlated with the combination of attributes A1 through AK and attribute values of attribute AL. Now, attribute AL is an attribute different from attributes A1 through AK, of the multiple attributes which the data dl through dn have.

That is to say, the creating unit 706 newly adds attributes to be represented in the chart, and creates a more refined chart regarding the consolidated data D1 through Dm (drill-down). For example, the attribute AL is set beforehand as to attributes A1 through AK, in accordance with user operation input selecting consolidated data D1 through Dm.

Specifically, for example, an arrangement may be made wherein, in the event that the user operation input is the first operation input, a chart is created by adding the attribute AL which has been set as to the attributes A1 through AK beforehand. That is to say, a new attribute AL further refining the consolidated data D1 through Dm is added in the event that the first operation input is performed directly instructing each consolidated data.

Note that the attribute AL to be newly added may be selected from attributes excluding attributes A1 through AK, out of the multiple attributes, by user operation input of the client apparatus 302 prior to creating of the chart by the creating unit 706. Also, there may be multiple attributes AL.

Also, the creating unit 706 may create a chart excluding any attribute Ak from the attributes A1 through AK. An attribute Ak to be executed from the attributes A1 through AK may be optionally set. That is to say, the creating unit 706 can create a chart adding new attributes to the attributes A1 through AK, excluding an attribute Ak from the attributes A1 through AK, or the like.

Specifically, for example, in the event that the user operation input is the second operation input, the creating unit 706 creates a chart with one of the attributes Ak out of attributes A1 through Ak changed to attribute AL. That is to say, in the event that second operation input is performed to specify a range including the consolidated data D1 through Dm, an attribute Ak from the attributes A1 through Ak is switched to another attribute to inclusively analyze the consolidated data D1 through Dm, and a chart representing this is created.

The transmission unit 707 has a function to transmit the chart information representing the created chart to the client apparatus 302. As a result, a further refined chart regarding the consolidated data D1 through Dm selected by the user will be displayed on the display 409 of the client apparatus 302.

Note that with the above description, a client apparatus 302 is provided separately from the information providing apparatus 301 as a computer for the user to use, but is not restricted to this arrangement. For example, the user may directly operate the information providing apparatus 301 to browse charts, select consolidated data, and so forth. In this case, the information providing apparatus 301 accepts user operation input for selecting consolidated data from the charts displayed on the display 409.

Also, the information providing apparatus 301 may output the searching conditions generated by the generating unit 703 to another computer capable of accessing the database 110. Thus, other computers can search the data to be analyzed.

Also, the information providing apparatus 301 may output data to be analyzed that has been searched by the searching unit 704 to another computer. Thus, other computers can create a further refined chart regarding the consolidated data D1 through Dm selected by the user.

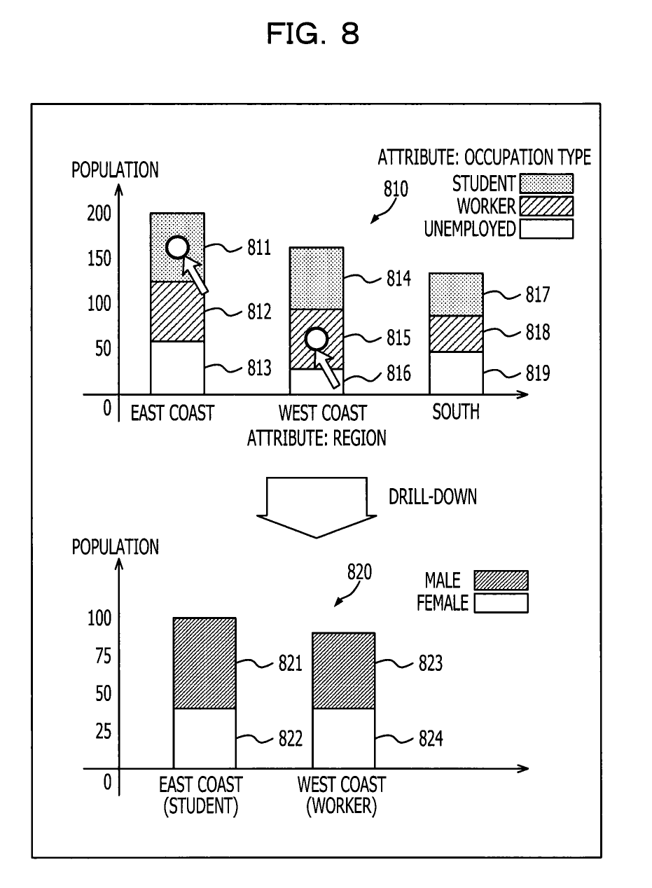

Next, an example of drill-down using the information providing apparatus 301 will be described with reference to FIGS. 8 through 11. FIG. 8 is an explanatory diagram illustrating an example of drill-down (part 1). In FIG. 8, a graph 810 is a bar graph representing population per occupation type for each region at a certain date and time (or period). The graph 810 is displayed on the display 409 of the client apparatus 302, for example. Note that the graph 810 is the same as the graph 120 illustrated in FIG. 1, and accordingly detailed description will be omitted here.

The user views the graph 810 displayed on the display 409, and selects consolidated data to be analyzed from the consolidated data 811 through 819 to drill down. In the example in FIG. 8, the consolidated data 811 and consolidated data 815 have been directly instructed by first operation input by the user by way of a left-click on the mouse 411 and pressing the control key on the keyboard 410.

In this case, the reception unit 701 receives accepting results including the identification information of the graph 810, the identification information of the consolidated data 811 and 815 selected from the graph 810, and operation information representing that the user operation input is first operation input, from the client apparatus 302.

Here, the user operation input is first operation input. Accordingly, the generating unit 703 generates a conditional expression Ea for searching for data where the combination of attribute values of attributes “region” and “occupation type” is the same as one of the consolidated data of consolidated data 811 and 815.

Ea=(“region=East coast” AND “occupation type=student”) OR (“region=West coast” AND “occupation type=worker”)

Next, the searching unit 704 searches from the data group d1 through dn stored in the database 110, for example, the data satisfying the generated conditional expression Ea (data to be analyzed). Note that we will assume a case of concentrating only on data of a certain date and time (or period) of the data group d1 through dn stored in the database 110.

Now, let us assume a case where attribute “gender” is set as an attribute to be newly added to create a further refined chart regarding consolidated data 811 and 815. That is to say, the new attribute “gender” is added to the attributes “region” and “occupation type”, to perform drill-down of the consolidated data 811 and 815.

In this case, the creating unit 706 creates a graph 820. The graph 820 is a bar graph representing population by gender for occupation type in each region at a certain date and time (or period). Specifically, the graph 820 is a chart in which, of the data to be analyzed, consolidated data 821 through 824 in which data of which the combination of attribute values of the attributes “region”, “occupation type”, and “gender” is the same, in a manner correlated with the attribute values.

Here, the consolidated data 821 represents that the population of gender “male” in region “East coast” with occupation type “student” is “60”. The consolidated data 822 represents that the population of gender “female” in region “East coast” with occupation type “student” is “40”. The consolidated data 823 represents that the population of gender “male” in region “West coast” with occupation type “worker” is “50”. The consolidated data 824 represents that the population of gender “female” in region “West coast” with occupation type “worker” is “40”.

The transmission unit 707 then transmits the created graph 820 to the client apparatus 302. As a result, the graph 820 is displayed on the display 409 of the client apparatus 302. Accordingly, the user can comprehend the population by gender according to occupation type in each region at a certain date and time (or period).

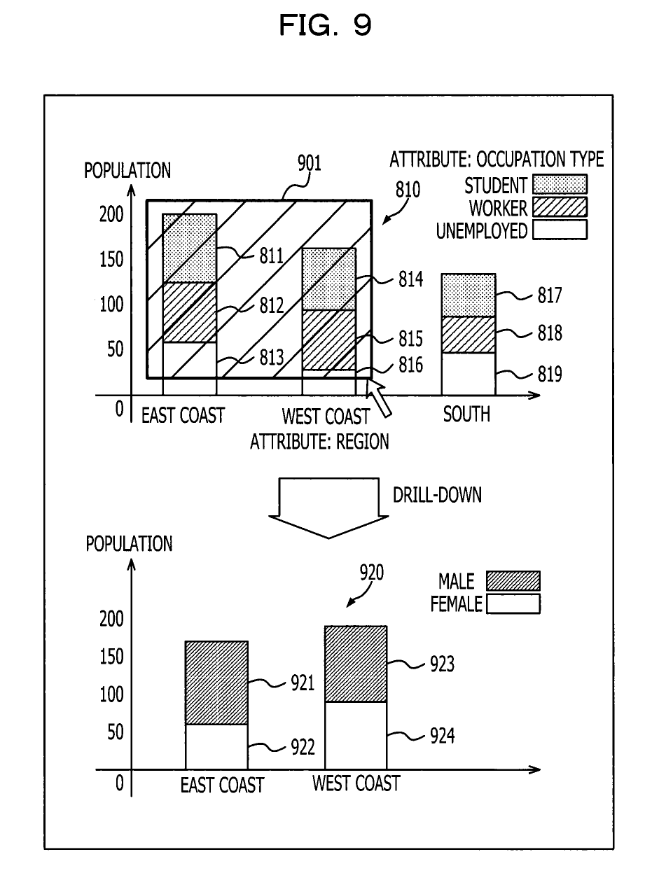

FIG. 9 is an explanatory diagram illustrating an example of drill-down (part 2). In FIG. 9, the graph 810 is a bar graph representing population per occupation type for each region at a certain date and time (or period). The graph 810 is displayed on the display 409 of the client apparatus 302, for example.

The user selects consolidated data regarding which drilling down and analyzing is desired from the consolidated data 811 through 819, while viewing the graph 810 displayed on the display 409. In the example in FIG. 9, a range 901 including consolidated data 811, 812, 814, and 815 displayed on the display 409 has been instructed by a user operation input performing a drag & drop operation of the mouse 411.

In this case, the reception unit 701 receives accepting results including the identification information of the graph 810, the identification information of the selected consolidated data 811, 812, 814, and 815, and operation information representing that the user operation input is second operation input, from the client apparatus 302.

Here, the user operation input is second operation input. Accordingly, a conditional expression Eb for searching for data where the attribute values of the attributes “region” and “occupation type” are the same as the attribute values corresponding to consolidated data of one of the consolidated data 811, 812, 814, and 815, is generated.

Eb=(“region=East coast” OR “region=West coast”) AND (“occupation type=student” OR “occupation type=worker”)

Next, the searching unit 704 searches for data to be analyzed that satisfies the generated conditional expression Eb, from the data group d1 through dn stored in the database 110, for example. Note that we will assume a case of concentrating only on data of a certain date and time (or period) of the data group d1 through dn stored in the database 110.

Now, at the time of inclusively analyzing the consolidated data 811, 812, 814, and 815, let us assume a case where attribute “gender” is set as an attribute to be newly added to create a further refined chart. That is to say, the new attribute “gender” is added to the attributes “region” and “occupation type”, to perform drill-down.

In this case, the creating unit 706 creates a graph 920. The graph 920 is a bar graph representing population by gender (occupation type: students, workers) in each region at a certain date and time (or period). Specifically, the graph 920 is a chart in which, of the data to be analyzed, consolidated data 921 through 924 in which is consolidated data of which the combination of attribute values of the attributes “region”, “occupation type”, and “gender” is the same, is represented in a manner correlated with the attribute values.

Here, the consolidated data 921 represents that the population of gender “male” in region “East coast” with occupation type “student or worker” is “110”. The consolidated data 922 represents that the population of gender “female” in region “East coast” with occupation type “student or worker” is “60”. The consolidated data 923 represents that the population of gender “male” in region “West coast” with occupation type “student or worker” is “100”. The consolidated data 924 represents that the population of gender “female” in region “West coast” with occupation type “student or worker” is “90”.

The transmission unit 707 then transmits the created graph 920 to the client apparatus 302. As a result, the graph 920 is displayed on the display 409 of the client apparatus 302. Accordingly, the user can comprehend the population by gender (occupation type: student and worker) according to occupation type in each region at a certain date and time (or period).

FIG. 10 is an explanatory diagram illustrating an example of drill-down (part 3). In FIG. 10, a graph 1000 is a chart representing population per occupation type every certain date and time. The graph 1000 is displayed on the display 409 of the client apparatus 302, for example.

The graph 1000 includes a graph 1010 representing the population of occupation type “student” every certain date and time, a graph 1020 representing the population of occupation type “worker” every certain date and time, and a graph 1030 representing the population of occupation type “unemployed” every certain date and time. The graph 1010 includes consolidated data 1011 through 1017. Also, the graph 1020 includes consolidated data 1021 through 1027. Further, the graph 1030 includes consolidated data 1031 through 1037.

Now, with graph 1010 as an example, the consolidated data 1011 represents that the population of occupation type “student” at date and time “2/1 00:00:00” is “90”. The consolidated data 1012 represents that the population of occupation type “student” at date and time “2/1 12:00:00” is “120”. The consolidated data 1013 represents that the population of occupation type “student” at date and time “2/2 00:00:00” is “30”.

The consolidated data 1014 represents that the population of occupation type “student” at date and time “2/2 12:00:00” is “20”. The consolidated data 1015 represents that the population of occupation type “student” at date and time “2/3 00:00:00” is “30”. The consolidated data 1016 represents that the population of occupation type “student” at date and time “2/3 12:00:00” is “10”. The consolidated data 1017 represents that the population of occupation type “student” at date and time “2/4 00:00:00” is “10”.

The user views the graph 1000 displayed on the display 409, and selects consolidated data to be analyzed from the consolidated data 1011 through 1017, 1021 through 1027, and 1031 through 1037, to drill down. In the example in FIG. 10, the consolidated data 1022 and consolidated data 1034 have been directly instructed by first operation input by the user by way of a left-click on the mouse 411 and pressing the control key on the keyboard 410.

In this case, the reception unit 701 receives accepting results including the identification information of the graph 1000, the identification information of the consolidated data 1022 and 1034 selected from the graph 1000, and operation information representing that the user operation input is first operation input, from the client apparatus 302.

Here, the user operation input is first operation input. Also, the attribute “date-and-time” type is a consecutive value type. Also, the granularity of the attribute is “one hour”, which is a time increment smaller than the plot interval “12 hours (the aforementioned average value h1)” on the graph 1000 and close to the time interval “one day (the aforementioned average value h2)” for the attribute “date-and-time” between the consolidated data 1022 and 1034.

Accordingly, the generating unit 703 generates a conditional expression Ec for searching for data where the combination of attribute values of attributes “occupation type” and “date-and-time” is the same as one of the consolidated data 1022 and 1034.

Ec=(“occupation type=worker” AND “date-and-time=2/1 12 o'clock”) OR (“occupation type=unemployed” AND “date-and-time=2/2 12 o'clock”)

Next, the searching unit 704 searches for data to be analyzed from the data group d1 through do stored in the database 110, which satisfies the generated conditional expression Ec. The granularity of the attribute “date-and-time” here is one hour. In this case, the creating unit 706 creates graphs 1040 and 1050. Note that the drawing illustrates a portion of the graphs 1040 and 1050 in an excerpted manner.

The graph 1040 is a flowchart representing population of occupation type “worker” at each certain date and time (time increment: one hour). The graph 1050 is a flowchart representing population of occupation type “unemployed” at each certain date and time (time increment: one hour). That is to say, the consolidated data 1022 and 1034 is refined by displaying the population by occupation type every time increment (one hour).

For example, in graph 1040, the consolidated data 1041 represents that the population of occupation type “worker” at date-and-time “2/1 12:00:00” is “210”. Also, the consolidated data 1042 represents that the population of occupation type “worker” at date-and-time “2/1 13:00:00” is “50”.

For example, in graph 1050, the consolidated data 1051 represents that the population of occupation type “worker” at date-and-time “2/2 12:00:00” is “160”. Also, the consolidated data 1052 represents that the population of occupation type “worker” at date-and-time “2/2 13:00:00” is “160”.

The transmission unit 707 then transmits the created graphs 1040 and 1050 to the client apparatus 302. As a result, the graphs 1040 and 1050 are displayed on the display 409 of the client apparatus 302. Accordingly, the user can comprehend the transition of population of occupation type “worker” each hour February 1 (from 12 o'clock). Also, the user can comprehend the transition of population of occupation type “unemployed” each hour February 2 (from 12 o'clock).

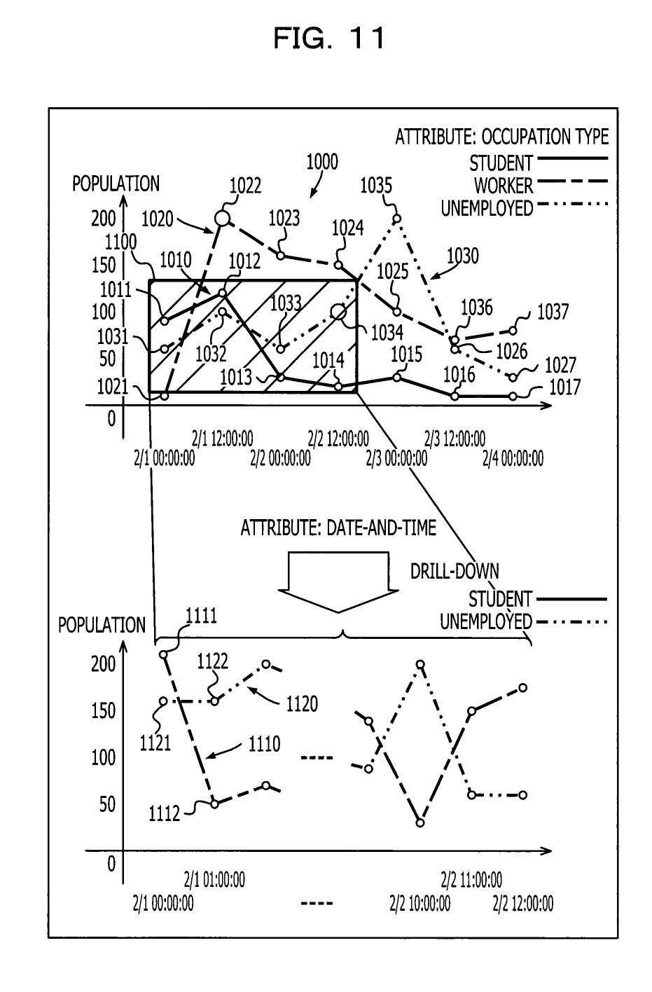

FIG. 11 is an explanatory diagram illustrating an example of drill-down (part 4). In FIG. 11, the graph 1000 is a chart representing population per occupation type every certain date and time. The graph 1000 is displayed on the display 409 of the client apparatus 302, for example.

The user views the graph 1000 displayed on the display 409, and selects consolidated data to be analyzed from the consolidated data 1011 through 1017, 1021 through 1027, and 1031 through 1037, to drill down. In the example in FIG. 11, a range 1100 including consolidated data 1011 through 1014 and 1031 through 1034 displayed on the display 409 has been instructed by user operation input using a drag & drop operation of the mouse 411.

In this case, the reception unit 701 receives accepting results including the identification information of the graph 1000, the identification information of the consolidated data 1011 through 1014 and 1031 through 1034 selected from the graph 1000, and operation information representing that the user operation input is second operation input.

Here, the user operation input is second operation input. Also, the attribute “date-and-time” type is a consecutive value type. Also, the granularity of the attribute “date-and-time” is “one hour”, due to the selection range on the graph 1000 (the above-described second interval) being half or less of the display range (above-described first interval).

Accordingly, the generating unit 703 generates a conditional expression Ed from the AND of conditional expressions for each of the attributes “occupation type” and “date-and-time”.

Ed=(“2/1 0 o'clock date-and-time” AND “date-and-time≦2/2 0 o'clock”) AND (“occupation type=student” OR “occupation type=unemployed”)

Next, the searching unit 704 searches for data to be analyzed from the data group d1 through do stored in the database 110, which satisfies the generated conditional expression Ed, for example. The granularity of the attribute “date-and-time” here is one hour. In this case, the creating unit 706 creates graphs 1110 and 1120. Note that the drawing illustrates a portion of the graphs 1110 and 1120 in an excerpted manner.

The graph 1110 is a flowchart representing population of occupation type “student” at each certain date and time (time increment: one hour). The graph 1120 is a flowchart representing population of occupation type “unemployed” at each certain date and time (time increment: one hour). That is to say, the consolidated data 1011 through 1014 and 1031 through 1034 is refined by displaying the population by occupation type every time increment (one hour).

For example, in graph 1110, the consolidated data 1111 represents that the population of occupation type “student” at date-and-time “2/1 00:00:00” is “210”. Also, the consolidated data 1112 represents that the population of occupation type “student” at date-and-time “2/1 01:00:00” is “50”.

For example, in graph 1120, the consolidated data 1121 represents that the population of occupation type “unemployed” at date-and-time “2/1 00:00:00” is “160”. Also, the consolidated data 1122 represents that the population of occupation type “unemployed” at date-and-time “2/1 01:00:00” is “160”.

The transmission unit 707 then transmits the created graphs 1110 and 1120 to the client apparatus 302. As a result, the graphs 1110 and 1120 are displayed on the display 409 of the client apparatus 302. Accordingly, the user can comprehend the transition of population of occupation type “student” each hour February 1 (from 0 o'clock). Also, the user can comprehend the transition of population of occupation type “unemployed” each hour February 1 (from 0 o'clock).

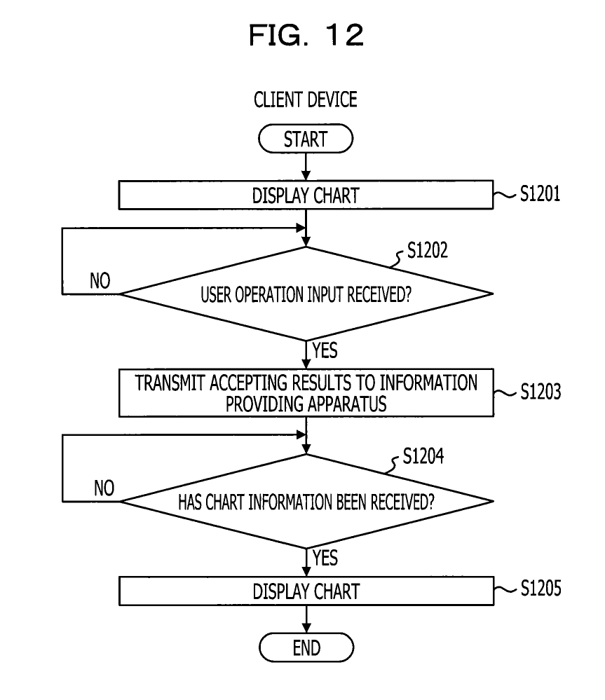

Next, description will be made regarding the chart display processing procedures of the client apparatus 302. FIG. 12 is a flowchart illustrating an example of the chart display processing procedures of the client apparatus 302. In the flowchart in FIG. 12, first, a chart is displayed on the display 409 by the display unit 602 (S1201). This chart is a chart which the chart information from the information providing apparatus 301 represents.

Next, the accepting unit 603 determines whether or not user operation input has been accepted in which consolidated data is selected from the chart displayed on the display 409 (S1202). Here, the accepting unit 603 awaits accepting of user operation input (No in S1202).

In the event that user operation input has been accepted (Yes in S1202), the transmission unit 604 transmits the accepted accepting results information to the information providing apparatus 301 (S1203). Next, the reception unit 601 determines whether or not chart information has been received from the information providing apparatus 301 (S1204).

Here, the reception unit 601 awaits for chart information to be received from the information providing apparatus 301 (No in S1204). In the event of the reception unit 601 having received chart information (Yes in S1204), the display unit 602 displays the chart which the received chart information represents on the display 409 (S1205), and the series of processing according to this flowchart ends.

Accordingly, a chart which the chart information provided from the information providing apparatus 301 represents can be displayed on the display 409. Also, in the event of having accepting user operation input selecting consolidated data from the chart displayed on the display 409, the accepting results can be notified to the information providing apparatus 301.

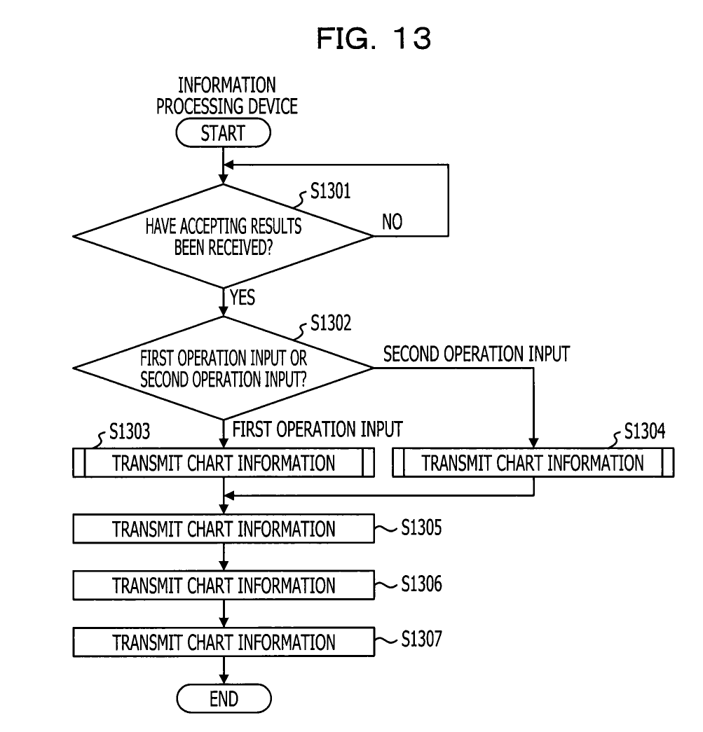

Next, description will be made regarding information providing processing procedures of the information providing apparatus 301. FIG. 13 is a flowchart illustrating an example of the information providing processing procedures of the information providing apparatus 301. In the flowchart in FIG. 13, first, the reception unit 701 determines whether or not accepting results have been received from the client apparatus 302 (S1301).

Now, the reception unit 701 awaits reception of the accepting results from the client apparatus 302 (No in S1301). In the event that accepting results are received by the reception unit 701 (Yes in S1301), the determining unit 702 determines whether or not the operation input selecting consolidated data D1 through Dm is first operation input or second operation input, based on the received accepting results (S1302).

In the event of the first operation input (first operation input in S1302), the generating unit 703 executes first generating processing for generating conditional expression E for searching for data to be analyzed from the data group d1 through do (S1303), and the flow transitions to S1305.

In the event of the second operation input (second operation input in S1302), the generating unit 703 executes second generating processing for generating conditional expression E for searching for data to be analyzed from the data group d1 through dn (S1304). The searching unit 704 then searches the data to be analyzed from the data group d1 through dn within the database 110, based on the generated searching conditions (S1305).

Next, the creating unit 706 creates chart information representing a new chart, based on the searched data to be analyzed (S1306). The transmission unit 707 then transmits the created chart information to the client apparatus 302 (S1307), and the series of processing according to this flowchart ends.

Accordingly, a chart according to the user operation input selecting the consolidated data D1 through Dm from the chart displayed on the display 409 can be created and provided to the client apparatus 302.

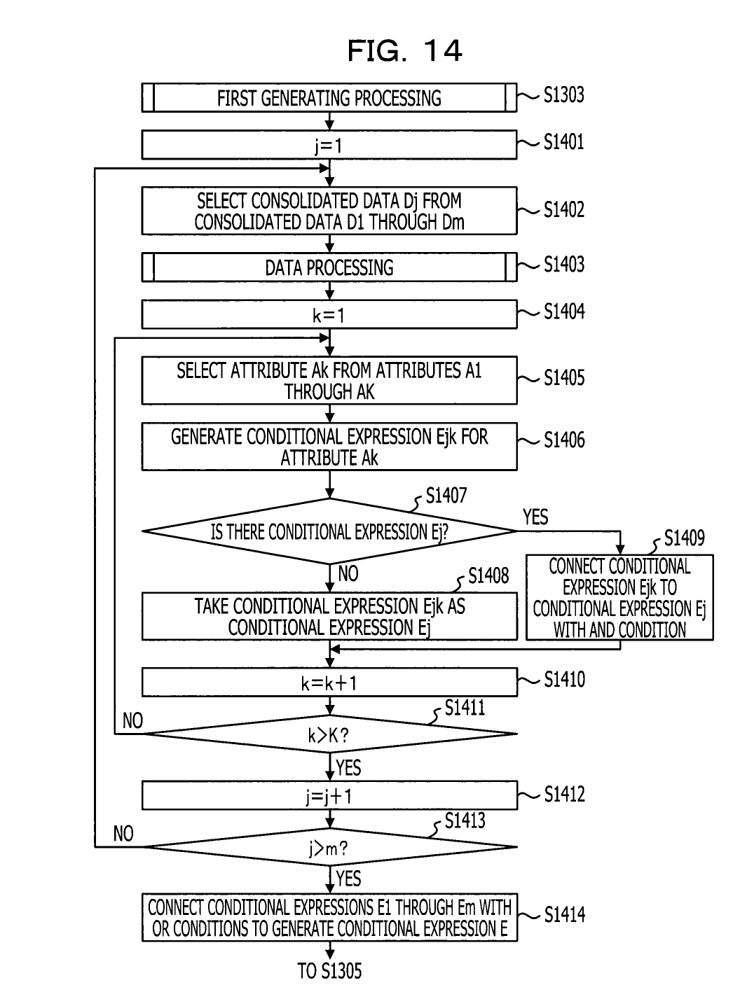

Next, description will be made regarding specific processing procedures of the first generating processing in S1303 illustrated in FIG. 13. FIG. 14 is a flowchart illustrating an example of specific processing procedures of the first generating processing. In the flowchart in FIG. 14, first, the generating unit 703 takes the “j” in the consolidated data Dj as “j=1” (S1401), and selects consolidated data Dj from the consolidated data D1 through Dm (S1402).

The generating unit 703 then executes data processing to process the selected consolidated data Dj (S1403). Next, the generating unit 703 takes “k” of attribute Ak as “k=1” (S1404), and selects attribute Ak from the attributes A1 through AK (S1405).

The generating unit 703 then generates a conditional expression Ejk for attribute Ak with regard to the consolidated data Dj (S1406). The conditional expression Ejk is “Ejk:Ak=Vⱼk”. Next, the generating unit 703 determines whether or not there is a conditional expression Ej regarding the consolidated data Dj (S1407).

Now, in the event that there is no conditional expression Ej (No in S1407), the generated conditional expression Ejk is taken as the conditional expression Ej (S1408), and the flow advances to S1410. On the other hand, in the event that there is a conditional expression Ej (Yes in S1407), the generating unit 703 connects the conditional expression Ej and the generated conditional expression Ejk by an AND condition (S1409).

The generating unit 703 then increments the “k” of attribute Ak (S1410), and determines whether or not “k” has exceeded “K” (S1411). Now, in the event that “k” is equal to or smaller than “K” (No in S1411), the flow returns to S1405.

On the other hand, in the event that “k” is greater than “K” (Yes in S1411), the generating unit 703 increments the “j” of the consolidated data Dj (S1412), and determines whether or not “j” has become greater than “m” (S1413).

In the event that “j” is equal to or smaller than “m” (No in S1413), the flow returns to S1402. On the other hand, in the event that “j” is greater than “m” (Yes in S1413), the generating unit 703 connects the conditional expressions E1 through Em of the consolidated data D1 through Dm with OR conditions to generate conditional expression E (S1414), and transitions to S1305 illustrated in FIG. 13.

Accordingly, a conditional expression E for searching for data from the data group d1 through do where the combination of attribute values of attributes A1 through AK is the same as one of the consolidated data Dj of consolidated data D1 through Dm, can be generated.

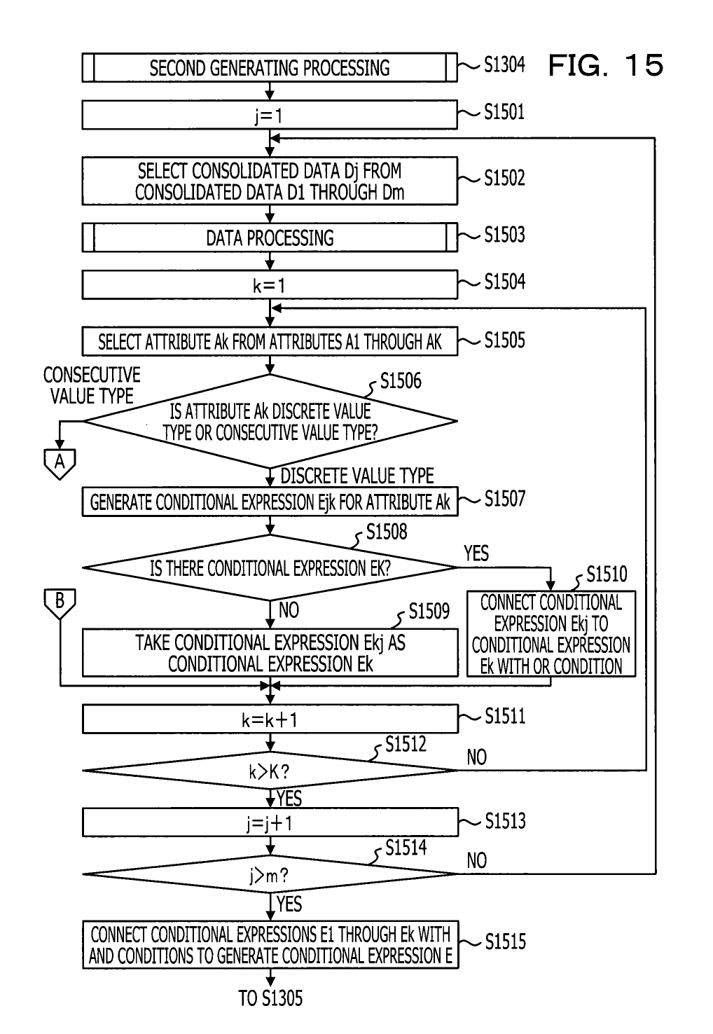

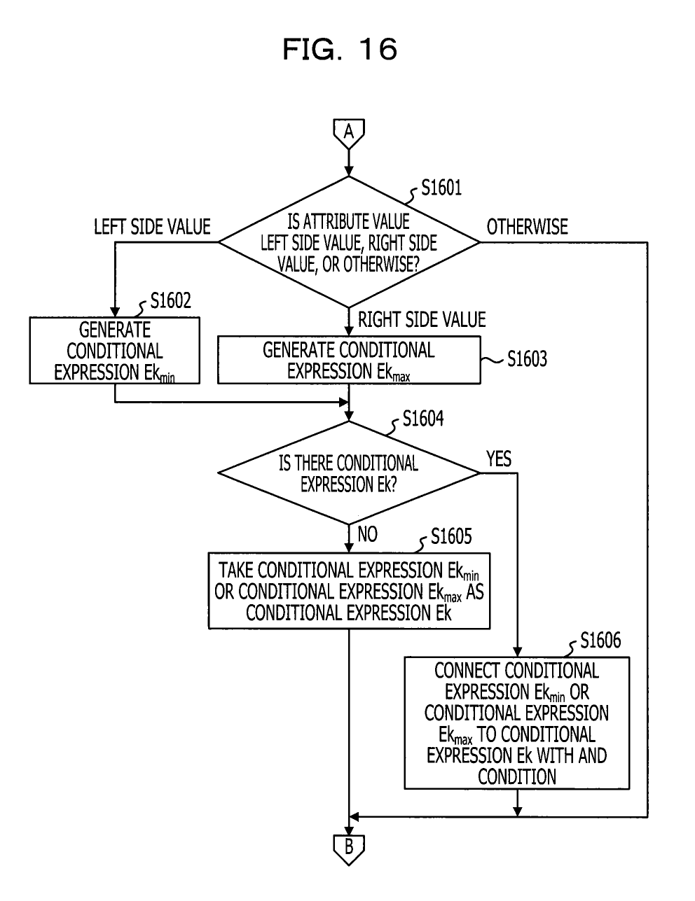

Next, description will be made regarding specific processing procedures of the second generating processing in S1304 illustrated in FIG. 13. FIGS. 15 and 16 are a flowchart illustrating an example of specific processing procedures of the second generating processing.

In the flowchart in FIG. 15, first, the generating unit 703 takes the “j” in the consolidated data Dj as “j=1” (S1501), and selects consolidated data Dj from the consolidated data D1 through Dm (S1502).

The generating unit 703 then executes data processing to process the selected consolidated data Dj (S1503). Next, the generating unit 703 takes “k” of attribute Ak as “k=1” (S1504), and selects attribute Ak from the attributes A1 through AK (S1505).

The determining unit 702 then determines whether the type of the attribute Ak is a discrete value type or consecutive value type (S1506). In the event that the type of the attribute Ak is a consecutive value type (consecutive value type in S1506), the flow transitions to S1601 in FIG. 16.

On the other hand, in the event that the type of the attribute Ak is a discrete value type (discrete value type in S1506), the generating unit 703 generates a conditional expression Ekj for attribute Ak (S1507). The conditional expression Ekj is “Ekj:Ak=Vⱼk”. Next, the generating unit 703 determines whether or not there is a conditional expression Ek regarding the attribute Ak (S1508).

Now, in the event that there is no conditional expression Ek (No in S1508), the generated conditional expression Ekj is taken as the conditional expression Ek (S1509), and the flow advances to S1511. On the other hand, in the event that there is a conditional expression Ek (Yes in S1508), the generating unit 703 connects the conditional expression Ek and the generated conditional expression Ekj by an OR condition (S1510).

The generating unit 703 then increments the “k” of attribute Ak (S1511), and determines whether or not “k” has exceeded “K” (S1512). Now, in the event that “k” is equal to or smaller than “K” (No in S1512), the flow returns to S1505.

On the other hand, in the event that “k” is greater than “K” (Yes in S1512), the generating unit 703 increments the “j” of the consolidated data Dj (S1513), and determines whether or not “j” has become greater than “m” (S1514).

In the event that “j” is equal to or smaller than “m” (No in S1514), the flow returns to S1502. On the other hand, in the event that “j” is greater than “m” (Yes in S1514), the generating unit 703 connects the conditional expressions E1 through EK of the attributes A1 through Am with AND conditions and generates conditional expression E (S1515), and transitions to S1305 illustrated in FIG. 13.

With the flowchart in FIG. 16, first, the generating unit 703 determines whether the attribute value Vⱼk of the attribute Ak of the consolidated data Dj is a left side value, right side value, or otherwise (S1601). The left side value is a value of the attribute values V₁k through Vₘk that is displayed to the farthest left on the display 409, and represents the smallest value of the attribute values V₁k through Vₘk. The right side value is a value of the attribute values V₁k through Vₘk that is displayed to the farthest right on the display 409, and represents the greatest value of the attribute values V₁k through Vₘk.

Now, in the event that the attribute value Vⱼk is the left side value (left side value in S1601), the generating unit 703 generates a conditional expression Ekₘᵢₙ for the attribute Ak (S1602), and the flow transitions to S1604. The conditional expression Ekₘᵢₙ is “conditional expression Ekₘᵢₙ: Vⱼk≦Ak”.

Also, in the event that the attribute value Vⱼk is the right side value (right side value in S1601), the generating unit 703 generates a conditional expression Ekₘₐₓ for the attribute Ak (S1603). The conditional expression Ekₘₐₓ is “conditional expression Ekₘₐₓ: Ak≦Vⱼk”.

The generating unit 703 then determines whether or not there is a conditional expression Ek regarding the attribute Ak (S1604). Now, in the event that there is no conditional expression Ek (No in S1604), the generated conditional expression Ekₘᵢₙ or conditional expression Ekₘₐₓ is taken as the conditional expression Ek (S1605), and the flow transitions to S1511 illustrated in FIG. 15.

On the other hand, in the event that there is a conditional expression Ek (Yes in S1604), the generating unit 703 connects the conditional expression Ek with the generated conditional expression Ekₘᵢₙ or conditional expression Ekₘₐₓ by an AND condition (S1606), and the flow transitions to S1511 illustrated in FIG. 15. Also, in the event that the attribute value Vⱼk is “otherwise” (otherwise in S1601), the flow transitions to S1511 illustrated in FIG. 15.

Accordingly, a conditional expression Ek can be generated to search from the data group d1 through dn for data where the attribute value of a discrete value type attribute Ak is the same as the attribute value of the attribute value Ak corresponding to consolidated data Dj of one of consolidated data D1 through Dm. Also, a conditional expression Ek can be generated to search from the data group d1 through dn for data where the attribute values of a consecutive value type attribute Ak is included in a range of minimum value Vkₘₘ through maximum value Vkₘₐₓ out of attribute values V₁k through Vₘk of the attribute Ak corresponding to consolidated data D1 through Dm. A conditional expression E serving as searching conditions for searching for data to be analyzed, from the data group d1 through dn, can be generated from the AND of the conditional expression Ek for each attribute Ak.

Next, specific processing procedures for the data processing in S1403 illustrated in FIG. 14 and S1503 in FIG. 15 will be described. Here, the data processing of S1403 illustrated in FIG. 14 will be described as an example.

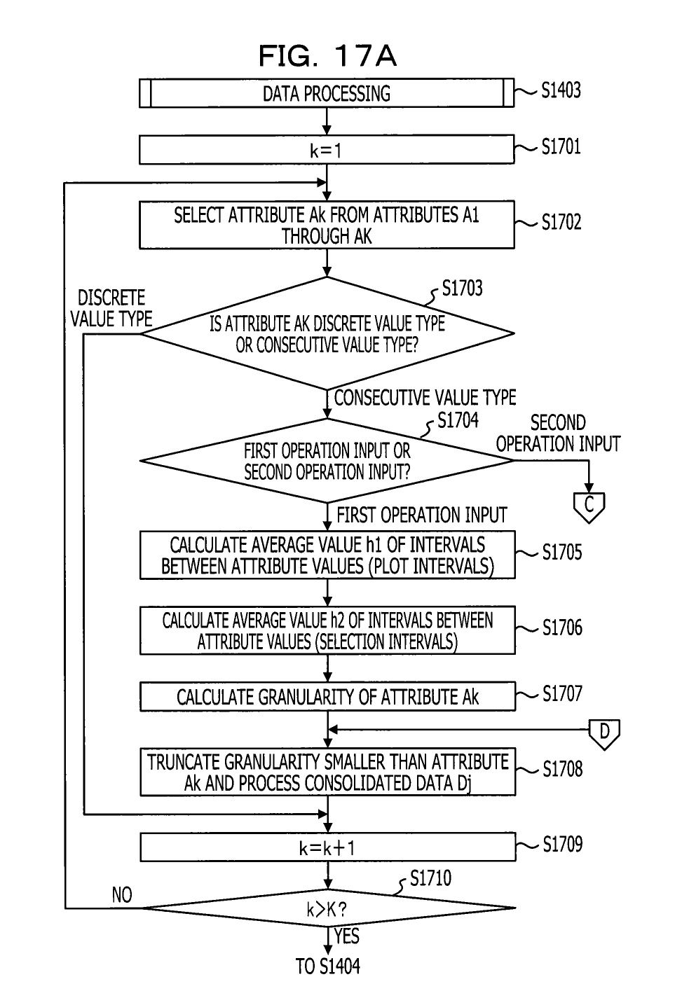

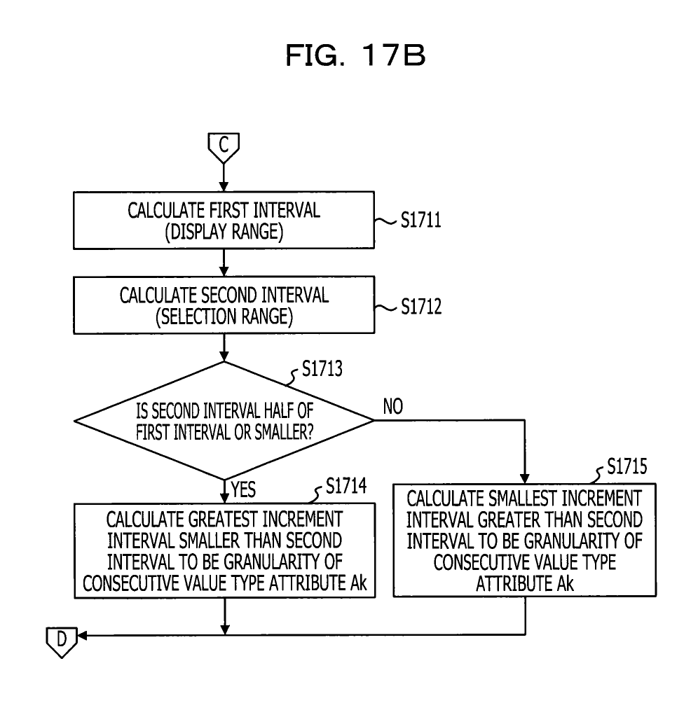

FIGS. 17A and 17B illustrate an exemplary flowchart of specified processing procedures for data processing. In the flowchart in FIGS. 17A and 17B, first, “k” in attribute Ak is taken as “k=1” by the generating unit 703 (S1701), and attribute Ak is selected from attribute A1 through Ak (S1702). The determining unit 702 then determines whether the type of the attribute Ak is discrete value type of consecutive value type (S1703).

Now, in the event that the type of the attribute Ak is a discrete value type (discrete value type in S1703), the flow advances to S1709. On the other hand, in the event that that the type of the attribute Ak is a consecutive value type (consecutive value type in S1703), The calculating unit 705 determines whether the operation input for selecting the consolidated data D1 through Dm is the first operation input or the second operation input (S1704).

Now, in the event of the first operation input (first operation input in S1704), the calculating unit 705 calculates the average value h1 of intervals between attribute values, based on the chart information representing the chart (S1705). This chart is a chart displayed on the display 409 of the client apparatus 302. Note that this average value h1 is an average value of intervals between consecutive different attribute values in the attribute values of consecutive value type attribute Ak in each consolidated data included in the chart (e.g., plot intervals).

Next, the calculating unit 705 calculates the average value h2 of temporal intervals between attribute values, based on the chart information representing the chart (S1706). Note that this average value h2 is an average value of temporal intervals between consecutive different attribute values in the attribute values V₁k through Vₘk of consecutive value type attribute Ak in the consolidated data D1 through Dm (e.g., selection intervals).

The calculating unit 705 then calculates an increment interval smaller than the average value h1, and an increment value close to the average value h2, as the granularity of the attribute Ak (S1707). Next, the generating unit 703 processes the consolidated data Dj by truncating granularity smaller than that of the attribute Ak, of the attribute value Vⱼk of attribute Ak in the consolidated data Dj (S1708).

The generating unit 703 then increments the “k” of attribute Ak (S1709), and determines whether or not “k” has exceeded “K” (S1710). Now, in the event that “k” is equal to or smaller than “K” (No in S1710), the flow returns to S1702. On the other hand, in the event that “k” is greater than “K” (Yes in S1710), the flow advances to S1404 in FIG. 14.

Also, in the event of the second operation input in S1704 (second operation input in S1704), the calculating unit 705 calculates a first interval based on the chart information representing the chart (S1711). The first interval is an interval between the smallest value and greatest value of the attribute values of the consecutive value type attribute Ak corresponding to each consolidated data included in the chart (e.g., display range).

Next, the calculating unit 705 calculates a second interval based on the chart information representing the chart (S1712). The second interval is an interval between the smallest value Vkₘᵢₙ and greatest value Vkₘₐₓ of the attribute values of the consecutive value type attribute Ak corresponding to consolidated data D1 through Dm (e.g., selection range).

The calculating unit 705 then determines whether this second interval is half or smaller than the first interval (S1713). In the event that the second interval is half or smaller than the first interval (Yes in S1713), the calculating unit 705 calculates the greatest increment interval smaller than the second interval to be the granularity of the consecutive value type attribute Ak (S1714), and the flow advances to S1708.

On the other hand, in the event that the second interval is greater than half of the first interval (No in S1713), the calculating unit 705 calculates the smallest increment interval greater than the second interval to be the granularity of the consecutive value type attribute Ak (S1715), and the flow advances to S1708. Accordingly, the consolidated data Dj can be processed to match the granularity of the consecutive value type attribute Ak.

As described above, with the information providing apparatus 301 according to the embodiment, searching conditions can be generated to search data to be analyzed, in accordance with user operation input selecting consolidated data D1 through Dm from a chart displayed on the display 409, so as to be drilled down for analysis. Specifically, the information providing apparatus 301 can determine whether the user operation input is first operation input directly specifying individual consolidated data on the display 409, or second operation input specifying a range including consolidated data D1 through Dm on the display 409. The information providing apparatus 301 can then generate a conditional expression E for searching for data to be analyzed from the data group d1 through dn, based on the combination of the determination results and the attribute values of attributes A1 through Ak corresponding to each consolidated data.

That is to say, in the event of the first operation input, the information providing apparatus 301 can generate a conditional expression E to search for data from the data group d1 through dn of which the combination of attribute values of attributes A1 through AK is the same as one of the consolidated data Dj from the consolidated data D1 through Dm.

Also, in the event of the second operation input, the information providing apparatus 301 can generate a conditional expression E to search for data from the data group d1 through dn of which the attribute values of attributes included in attributes A1 through AK are the same as the consolidated data Dj from the consolidated data D1 through Dm. More specifically, a conditional expression Ek can be generated to search for data from the data group d1 through dn, of which attribute values of a discrete value type attribute Ak are the same as attribute values of attribute Ak corresponding to one of consolidated data Dj from the consolidated data D1 through Dm. Also, a conditional expression Ek can be generated to search for data from the data group d1 through dn, of which attribute values of a consecutive value type attribute Ak are included in a range of minimum value Vkₘᵢₙ through maximum value Vkₘₐₓ of the attribute values V₁k through Vₘk of the attribute Ak corresponding to the consolidated data D1 through Dm. A conditional expression E serving as searching conditions to search for data to be analyzed from the data group d1 through dn can then be generated from the AND of the conditional expressions Ek for each attribute Ak.

Thus, the intent of the user which has selected the consolidated data D1 through Dm can be determined in accordance with the user operation input selecting the consolidated data D1 through Dm to be drilled down an analyzed, from the chart displayed on the display 409. As a result, data to be analyzed which can create a chart which the user expects can be searched for, by determining the AND conditions, OR conditions, and magnitude conditions of the attribute values of attributes A1 through Ak among the selected consolidated data.

Also, the information providing apparatus 301 can create a new chart based on the data to be analyzed that has been searched from the data group d1 through dn, using the generated conditional expression E. For example, a new attribute AL can be added, and a chart can be created representing the consolidated data obtained by consolidating the data to be analyzed that has been searched with the same combination as with the attribute values of attributes A1 through AK and attribute AL.

Specifically, for example, in the event that the user operation input is the first operation input, the information providing apparatus 301 can create a chart adding the attribute AL, which has been set beforehand, to the attributes A1 through AK. Accordingly, a chart can be created where the consolidated data D1 through Dm is represented in a further refined manner.

Also, for example, in the event that the user operation input is the second operation input, the information providing apparatus 301 can create a chart in which one attribute Ak from attributes A1 through AK is changed to the attribute AL. Accordingly, a chart can be created where one attribute Ak from attributes A1 through AK is changed to another attribute, to inclusively analyze the consolidated data D1 through Dm.

Also, in the case of the first operation input, the information providing apparatus 301 can calculate the granularity of a consecutive value type attribute Ak, based on intervals between consecutive different attribute values out of the attribute values of consecutive value type attribute Ak corresponding to each consolidated data included in the chart.

Also, in the case of the second operation input, the information providing apparatus 301 can calculate the granularity of a consecutive value type attribute Ak, based on first interval and second interval. The first interval is the interval between the minimum value and maximum value of attribute values of consecutive value type attribute Ak corresponding to each consolidated data included in the chart. The second interval is the interval between minimum value Vkₘᵢₙ and maximum value Vkₘₐₓ of the attribute values of the consecutive value type attribute Ak corresponding to the consolidated data D1 through Dm.

Thus, by calculating the granularity of the attribute Ak corresponding to user operation input regarding a consecutive value type attribute Ak, determination can be made regarding how the user wants to drill down, i.e., what sort of data intervals the user desires to be displayed. As a result, data can be displayed with the granularity of the attribute Ak (e.g., in increments of one hour), with regard to the consecutive value type attribute Ak, for example.

Note that the generating method and support method of searching described in the embodiment can be realized by executing a program prepared beforehand with a computer such as a personal computer or workstation or the like. The generating program and support program of searching is recorded in a computer-readable recording medium such as a hard disk, flexible disk, CD-ROM, MO, DVD, or the like, and is read out from the recoding medium by the computer and executed. Also, the generating program and support program of searching may be distributed over a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A support method of searching, comprising:
in a case that a plurality of display elements each of which is associated with attributes are specified, generating a search condition including attributes associated with the plurality of display elements, and a logical operator corresponding to a specifying method by which the plurality of display elements were specified, by a processor.

2. The support method according to claim 1, wherein
the plurality of display elements are respectively associated with a plurality types of attributes.

3. The support method according to claim 2, wherein
the search condition includes condition elements connected each other,
in a case that the plurality of display elements are individually specified, the condition elements, each of which is a condition regarding one of the plurality of display elements, are connected by a logical OR operator, and
in a case that the plurality of display elements are specified by range specification, the condition elements, each of which is a condition regarding one of the plurality types, are connected by a logical AND operator.

4. The support method according to claim 3, wherein
the condition regarding the one of the plurality of display elements includes the plurality types of attributes, which are associated with the one of the display elements, connected by a logical AND operator.

5. The support method according to claim 3, wherein
in a case that attributes belonging to the one of the plurality types are expressed as discrete values, the condition regarding the one of the plurality type includes the attributes, which are belonging to the one of the plurality types, connected by a logical OR operator, and
in a case that attributes belonging to the one of the plurality types are expressed as consecutive values, the condition regarding the one of the plurality type is designation of a range based on the attributes belonging to the one of the plurality types.

6. The support method according to claim 1, further comprising:
searching based on the generated search condition; and
outputting a result of the searching.

7. The search support method according to claim 6, wherein
the result includes data retrieved by the searching which are associated with another type of attributes, the another type being different from any one of the plurality type.

8. The support method according to claim 1, wherein
the attributes included in the generated search condition are connected each other by the logical operator.

9. A computer-readable recording medium storing a support program of searching that causes a computer to execute a procedure, the procedure comprising:
in a case that a plurality of display elements each of which is associated with attributes are specified, generating a search condition including attributes associated with the plurality of display elements, and a logical operator corresponding to a specifying method by which the plurality of display elements were specified.

10. The recording medium according to claim 9, wherein
the search condition includes condition elements connected each other,
in a case that the plurality of display elements are individually specified, the condition elements, each of which is a condition regarding one of the plurality of display elements, are connected by a logical OR operator, and
in a case that the plurality of display elements are specified by range specification, the condition elements, each of which is a condition regarding one of the plurality types, are connected by a logical AND operator.

11. The recording medium according to claim 10, wherein
the condition regarding the one of the plurality of display elements includes the plurality types of attributes, which are associated with the one of the display elements, connected by a logical AND operator.

12. The recording medium according to claim 10, wherein
in a case that attributes belonging to the one of the plurality types are expressed as discrete values, the condition regarding the one of the plurality type includes the attributes, which are belonging to the one of the plurality types, connected by a logical OR operator, and
in a case that attributes belonging to the one of the plurality types are expressed as consecutive values, the condition regarding the one of the plurality type is designation of a range based on the attributes belonging to the one of the plurality types.

13. The recording medium according to claim 9, wherein the procedure further comprising:
searching based on the generated search condition; and
outputting a result of the searching.

14. The recording medium according to claim 13, wherein
the result includes data retrieved by the searching which are associated with another type of attributes, the another type being different from any one of the plurality type.

15. A support apparatus of searching comprising:
interface that receives input information; and
a processor that executes a procedure, the procedure including:
in a case that a plurality of display elements each of which is associated with attributes are specified by the input information, generating a search condition including attributes associated with the plurality of display elements, and a logical operator corresponding to a specifying method by which the plurality of display elements were specified.

16. The support apparatus according to claim 15, wherein
the search condition includes condition elements connected each other,
in a case that the plurality of display elements are individually specified, the condition elements, each of which is a condition regarding one of the plurality of display elements, are connected by a logical OR operator, and
in a case that the plurality of display elements are specified by range specification, the condition elements, each of which is a condition regarding one of the plurality types, are connected by a logical AND operator.

17. The support apparatus according to claim 16, wherein
the condition regarding the one of the plurality of display elements includes the plurality types of attributes, which are associated with the one of the display elements, connected by a logical AND operator.

18. The support apparatus according to claim 16, wherein
in a case that attributes belonging to the one of the plurality types are expressed as discrete values, the condition regarding the one of the plurality type includes the attributes, which are belonging to the one of the plurality types, connected by a logical OR operator, and
in a case that attributes belonging to the one of the plurality types are expressed as consecutive values, the condition regarding the one of the plurality type is designation of a range based on the attributes belonging to the one of the plurality types.

19. The support apparatus according to claim 15, wherein the procedure further including:
searching based on the generated search condition; and
outputting a result of the searching.

20. The support apparatus according to claim 19, wherein
the result includes data retrieved by the searching which are associated with another type of attributes, the another type being different from any one of the plurality type.
